(19) United States
(12) Patent Application Publication
(10) Pub. No.: US 2015/0040524 A1
(43) Pub. Date: Feb. 12, 2015

(54) SADDLE CLOTH

(71) Applicant: ACAVALLO S.r.l., Lonato del Garda (IT)

(72) Inventor: Mauro BENETTI, Lonato del Garda (IT)

(73) Assignee: ACAVALLO S.r.I., Lonato del Garda (IT)

(21) Appl. No.: 13/963,130

(22) Filed: Aug. 9, 2013

(51) Int. Cl. B68C 1/12

(52) U.S. Cl. CPC B68C 1/126
USPC 54/66

(57) ABSTRACT

A saddle cloth includes a flexible base having a first and a second surface separated across the base's thickness. Pillar-shaped elements extend from at least one of the surfaces so as to distance the base from a mating surface that contacts the elements and to create therebetween an air gap. At least one of the pillar-shaped elements is internally hollow, its cavity opening in an opposite direction to the respective first and/or second surface.

### BACKGROUND OF THE INVENTION

1. Field of invention

The present invention relates to a saddle cloth for animals to be ridden by humans, and in particular for horses.

2. Description of the Prior Art

It is known to interpose a matt-shaped material between a horse's back and an equestrian's saddle. One of the main purposes of this material is to prevent the saddle from slipping from the animal, and to thereby cause injury to the horseman.

These materials are usually made of natural or synthetic laminates, and are subject to quite harsh conditions in terms of temperature due to the equestrian's load and to the horse's body heat, in terms of abrasion because of the continuous shearing forces acting between the saddle and the animal's back, and of humidity due to the horse's sweat.

One of the main drawbacks of the commonly available matts is that the combined action of wetness and abrasion progressively reduces the material grip on the horse or on the saddle, so that the danger of casualties increases.

### SUMMARY OF THE INVENTION

The problems that are lamented in the prior art are herewith overcome through a saddle cloth comprising a flexible base with a first and a second surface separated across the base's thickness, a plurality of pillar-shaped elements extending from at least one of said surfaces so as to distance said base from a mating surface that contacts said elements and to create therebetween an air gap, at least one of said pillar-shaped elements being internally hollow, its cavity opening in an opposite direction to the respective first and/or second surface.

### BRIEF DESCRIPTION OF THE DRAWINGS

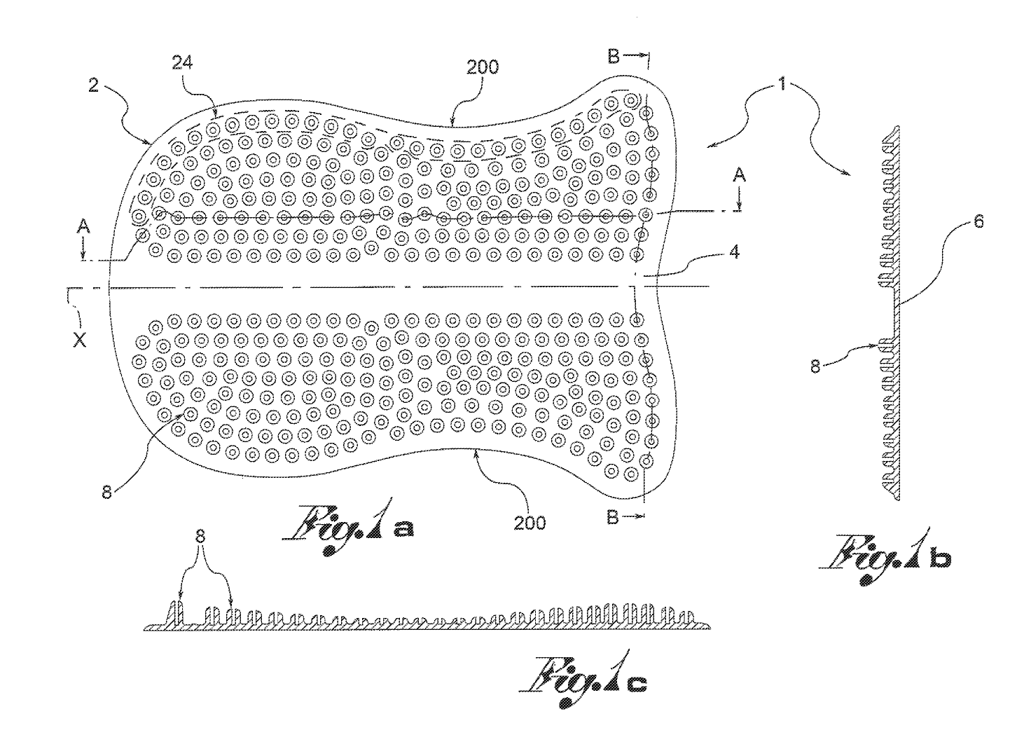

The object of the present invention will now be discussed with reference to the enclosed figures, wherein FIGS. 1a, 1b, 1c; 2a, 2b, 2c; 3a, 3b, 3c and 4a, 4b, 4c show plan and two section views of four embodiments of a saddle cloth according to the present invention, figures “a” being plan views, figures “b” and “c” being sections taken along the lines depicted in the respective figures “a”.

### DESCRIPTION OF THE PREFERRED EMBODIMENT

With reference to the previously mentioned drawings, reference sign 1 globally indicates a saddle cloth according to the present invention.

Even though the preferred use of the present saddle cloth 1 is its placing between a saddle and an animal, an additional or alternative use could envisage the saddle cloth to rest on an upper, sitting surface of the saddle, so as to interpose between the saddle and a horseman. According to this embodiment it would be possible to obtain comparable advantages in terms of resiliency and of anti-slipping contact.

Saddle cloth 1 comprises a flexible base 2 comprising a first 4 and a second 6 surface separated across the base's thickness, and a plurality of pillar-shaped elements 8, 10 extending from at least one of said surfaces 4, 6 so as to distance said base 2 from a mating surface 12, 12′ that contacts said elements, and hence to create an air gap 16 between the flexible base and the mating surface.

For example the mating surface could be—according to the different uses of the saddle cloth—an underside of a saddle, or the skin of an animal, or both of them for the embodiments wherein the pillar-shaped elements 8, 10 are provided on both sides of the flexible base 2.

According to an embodiment, the flexible base 2 has a generally or substantially rectangular shape, seen in a plan view. Optionally, this rectangular shape could delimit opposed recesses 200 on the greater sides that, during use, are suitable for being positioned at the articulations of the animal front limbs.

Advantageously, the base 2 is longer in a longitudinal direction X than in a transversal direction Y. E.g. these directions are orthogonal to each other.

Advantageously, a central longitudinal portion 18 of said flexible base 2 is free from pillar-shaped elements 8, 10. Said longitudinal portion is in particular configured for abutting directly or resting “indirectly” (i.e. through the thickness of the flexible base) on the spine of a ridden animal.

According to a preferred embodiment, the pillar-shaped elements 8, 10 extend both from the first 4 and from the second surface 6 of the flexible base 2, so that air spaces are created on both sides of said flexible base.

For saddle cloths with a bi-lateral disposition of such elements, each pillar-shaped element 8, 10 on the first surface 4 is preferably at least partially misaligned to the pillar-shaped elements 8, 10 on the second surface 6.

Even more preferably, a pillar-shaped element 8, 10 on the first surface 4 is interstitial to the pillar-shaped elements 8, 10 on the second surface 6, or vice versa.

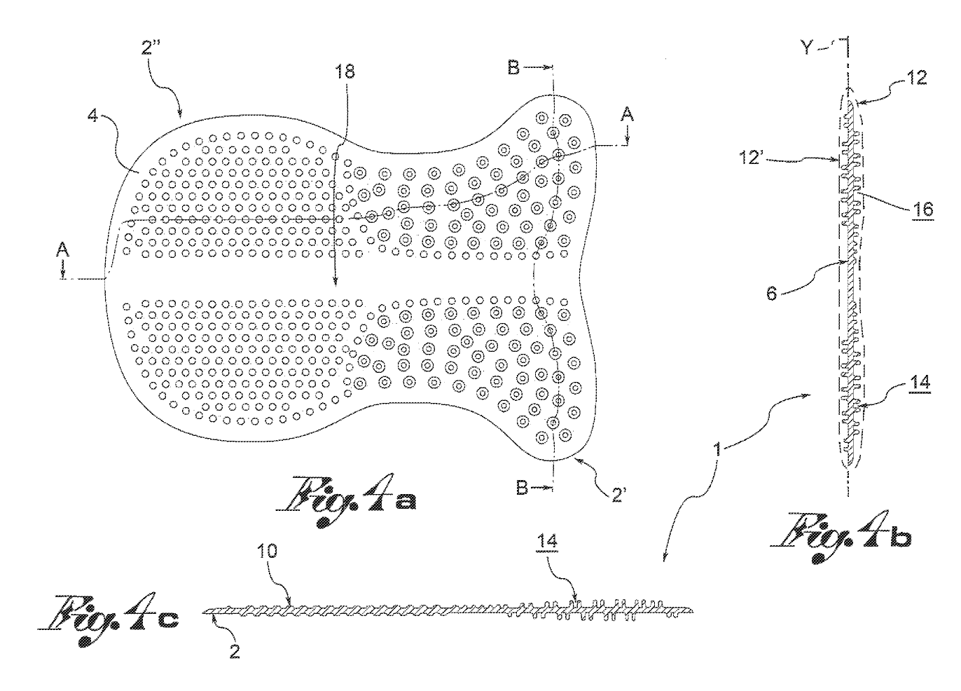

In the present description the term “interstitial” will be intended to mean that at least one element on the first surface will be situated in a space intervening between two or more elements on the second surface (or vice versa). Such lattice-like disposition is for example schematized through the dotted lines in FIG. 4a, showing the elements on the reverse side.

According to a preferred embodiment, the air gap 16 (or the plurality thereof) extends substantially continuously along the flexible base 2, and is advantageously crossed by a plurality of pillar-shaped elements 8, 10 making discrete contact points to the mating surface 12, 12′.

According to a further embodiment, the flexible base 2 and the pillar-shaped elements 8, 10 are produced or molded in a single piece with each other, preferably in a waterproof, in a water-repellent material, or in any case in a material with reduced or no porosity.

For example, the flexible base 2 and/or the pillar-shaped elements 8, 10 are made in a silicon, in a polymer or in an elastomer material.

As a non limiting example, said material could be selected from the group consisting in thermoplastic gels, polyvinyl chloride, polyvinyl chloride foam, polyolefin foam obtained using ethylene vinyl acetate and metallocene polyethylene, gelatinous elastomer, gelatinous visco-elastomer, monoalkenylarene polymers, a copolymer made by the combination of butadiene and isoprene, polystyrene and functionalized polystyrene, polyethylene, polybutylene, poly(ethylene/butylene), hydrogenated poly(isoprene), hydrogenated poly(butadiene), hydrogenated poly(isoprene+butadiene), poly(ethylene/propylene) or hydrogenated poly(ethylene/butylene+ethylene/propylene), and mixtures thereof.

According to the present invention, at least one 10 of said pillar-shaped elements is internally hollow, the cavity 14 of this hollow pillar-shaped element opening in an opposite direction to the respective first 4 and/or second 6 surface.

This way, the hollow pillar-shaped element 10 is configured for performing a sucking action on the mating surface 12, 12′.

In other words, the cavity 14 of the hollow pillar-shaped element 10 is preferably sufficiently large and/or deep so as to act as a sucker on the mating surface 12, 12′. This sucking action is preferably of a moderate intensity, so as to avoid damaging the mating surface.

This way, once the saddle cloth has been put in a desired position, it keeps this precise position at least in relation to one of the mating surfaces. Any movement of the mating surface relatively to the animal (or to the saddle) will involve no repositioning of the saddle cloth moving integrally to said surface.

Preferably, the saddle cloth 1 comprises many pillar-shaped element 10, only some of which are hollow, and distributed on the flexible base.

According to a variant, the hollow pillar-shaped element 10 or the plurality thereof is combined with solid (i.e. cavity-free) pillar-shaped elements 8 extending from the first 4 and/or from the second 6 surface.

Preferably, the solid pillar-shaped elements are smaller in diameter/section than the hollow elements, advantageously also smaller in height; even more preferably, said solid elements are distributed with a smaller surface density than the hollow pillar-shaped elements.

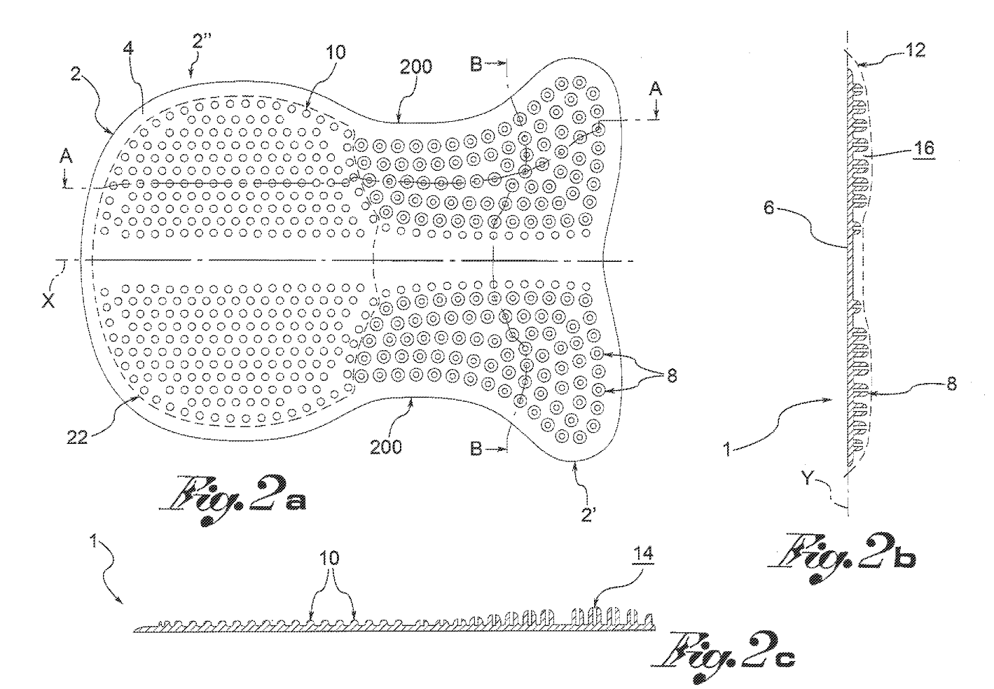

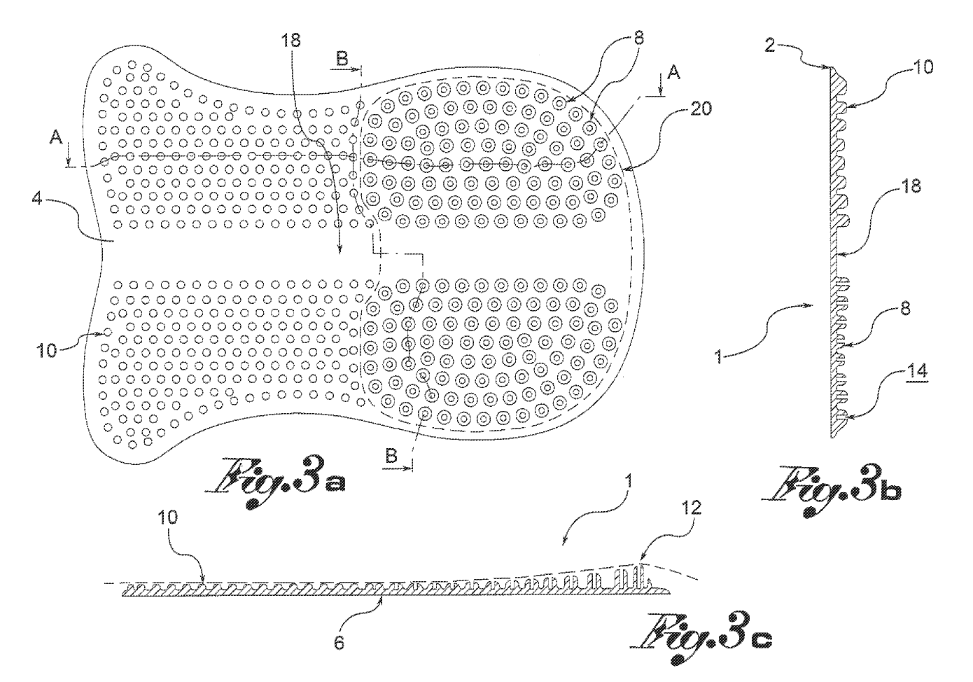

According to possible embodiments, the flexible base comprises only hollow pillar-shaped elements 10 (FIG. 1a), or a plurality of hollow pillar-shaped elements 10 is grouped mainly in a forward (FIG. 2a; wherein the solid pillar-shaped elements occupy a backward zone 22) or in a backward 20 (FIG. 3a) half of the flexible base 2.

According to a further embodiment, the hollow pillar-shaped elements 10 could be distributed along at least a rim portion 24 of said flexible base 2.

Preferably, along the longitudinal direction X, the height of the hollow pillar-shaped elements 10 decreases from at least an end portion 2′, 2″ of the flexible base 2 towards a central portion of the same.

Even more preferably, along the transversal direction Y, the height of the hollow pillar-shaped elements 10 is substantially constant.

Advantageously, according to the present saddle cloth the creation of two air spaces does not involve an excessive material thickness that could lead to discomfort for the animal or for the rider.

Advantageously, the present saddle cloth cannot be wetted, and in any case the eventual humidity coming into contact with the pillar-shaped elements strengthens the connection to the mating surface.

Advantageously, the present saddle cloth is simple in structure and very cheap to be produced.

Advantageously, the present saddle cloth has been designed for providing an optimum comfort for the animal and/or for the rider.

Advantageously, the present saddle cloth allows to continuously remove humidity from the air space, this space being in communication with the outside environment.

Also, the reduced contact surface of the inventive saddle cloth with the mating surface favors the animal's natural transpiration.

Advantageously, the shockabsorbing property of the present saddle cloth allows to reduce micro-trauma both for the rider's back and for the horse's back. In particular, the dampened pressure on the horse's scapula, which is a very sensible region, has a massaging effect which stimulates the flow of blood.

To the embodiments of the aforementioned saddle cloth, a skilled person could make variations to the described elements with equivalent ones.

Also such variants fall within the scope of protection of the present invention.

Also, any of the above variant may be implemented independently of the other embodiments shown.

1. Saddle cloth comprising a flexible base comprising:
a first and a second surface separated across thickness of the base;
a plurality of pillar-shaped elements extending from at least one of said surfaces to distance said base from a mating surface that contacts said elements and to create therebetween an air gap, at least one of said pillar-shaped elements being internally hollow, the hollow pillar-shaped element having a cavity opening in an opposite direction to the respective first and/or second surface.

2. Saddle cloth according to claim 1, wherein the hollow pillar-shaped element is configured for performing a sucking action on the mating surface.

3. Saddle cloth according to claim 1, wherein the cavity of the hollow pillar-shaped element is sufficiently large and/or deep to act as a sucker on the mating surface.

4. Saddle cloth according to claim 1, wherein the air gap extends substantially continuously along the flexible base and is crossed by a plurality of pillar-shaped elements making discrete contact points to the mating surface.

5. Saddle cloth according to claim 1, wherein the hollow pillar-shaped element is combined with solid or cavity-free pillar-shaped elements extending from the first and/or from the second surface.

6. Saddle cloth according to claim 1, wherein the flexible base and the pillar-shaped elements are produced or molded in a single piece with each other.

7. Saddle cloth according to claim 1, wherein the flexible base and the pillar-shaped elements are made in a waterproof or in a water-repellent material.

8. Saddle cloth according to claim 1, wherein the flexible base and/or the pillar-shaped elements are made of a silicon, a polymer or an elastomer material.

9. Saddle cloth according to claim 1, wherein a central longitudinal portion of said flexible base is free from pillar-shaped elements, said longitudinal portion being configured for abutting directly or resting indirectly on the spine of a ridden animal.

10. Saddle cloth according to claim 1, comprising a plurality of hollow pillar-shaped elements grouped mainly in a forward or in a backward half of the flexible base.

11. Saddle cloth according to claim 1, wherein the hollow pillar-shaped elements are distributed along at least a rim portion of said flexible base.

12. Saddle cloth according to claim 1, wherein, in a longitudinal direction, the height of the pillar-shaped elements decreases from at least an end portion of the flexible base towards a central portion of the flexible base.

13. Saddle cloth according to claim 1, wherein, in a transversal direction, the height of the pillar-shaped elements is substantially constant.

14. Saddle cloth according to claim 1, wherein pillar-shaped elements extend both from the first surface and from the second surface of the flexible base, so that air spaces are created on both sides of said base, said pillar-shaped elements being optionally hollow.

15. Saddle cloth according to claim 14, wherein each pillar-shaped element on the first surface is at least partially misaligned to the pillar-shaped elements on the second surface.

16. Saddle cloth according to claim 14, wherein at least a pillar-shaped element on the first surface is interstitial to a group of pillar-shaped elements on the second surface, or vice versa.
